(19) United States
(12) Patent Application Publication
(10) Pub. No.: US 2010/0108777 A1
(43) Pub. Date: May 6, 2010

(54) Hazing System Having Haze Recapture Control

(76) Inventor: Michael T. O'Brien, Miami, FL (US)

Correspondence Address: WILLIAM D. HARE, 66 WITHERSPOON STREET, STE. 1, PMB 317, PRINCETON, NJ, 08542-9944, US

(21) Appl. No.: 12/608,996

(22) Filed: Oct. 29, 2009

Related U.S. Application Data
(60) Provisional application No. 61/109,772, filed on Oct. 30, 2008.

(51) Int. Cl. B05B 17/00; B05B 1/20; B05B 7/00

(52) U.S. Cl. 239/8; 239/566; 239/569

(57) ABSTRACT

The invention relates to a hazer system that includes a base unit, an air capture unit and an air return line. The base unit is configured to hold a haze fluid and produce a haze, and has one or more outlets from which the haze is emitted. The air capture unit has one or more openings through which a negative pressure exists to capture at least a portion of the haze produced by the base unit. The air return line is configured to return at least a portion of the captured haze to the base unit and/or exhaust at least a portion of the capture haze.

### TECHNICAL FIELD

The field of the invention generally relates to systems and methods for providing visual lighting effects.

### BACKGROUND

Hazers are used in a variety of performances, such as rock concerts, plays, events, etc. to assist in providing a lighting effect. Haze machines, or haze generators, are commonly referred to as hazers. Hazers are similar to fog machines in that they produce droplets suspended in the air which are designed to make light beams visible. The haze that is produced is typically very thin and should be barely noticeable, if at all, under normal lighting conditions. This is in contrast to the fog produced by a fog machine which can be thick enough to be opaque. This difference between a haze and a fog allows the operator of the system to fill a venue with haze prior to an event without creating a visibly distracting cloud.

The haze also has a substantially longer hang time than a conventional fog. While a conventional fog may hang in the air for up to five minutes, a typical water-based haze can last one hour and an oil-based haze can last up to six hours or more, depending on the size of the venue and the amount of ventilation. Most water-based fluids use either a glycol, polyglycol, or glycerol base and most oil-based haze fluids use a mineral oil base. The haze is created by using either a heater to vaporize the fluid, in the case of a water-based fluid, or a compressor to atomize the fluid, in the case of an oil-based fluid. A pump is used to distribute the haze into a room or venue.

Referring to FIG. 1, a prior art hazer system 50 includes a base unit 55 with an outlet 60. The system heats a haze fluid that exits the base unit 55 through the outlet 60 as a plume of vapor or gas 65. Light can passed through the plume 65 to create visual effects. The plume disperses over time into the atmosphere of the room or auditorium. In use, the haze fluid is moved into a heat exchanger by a pump. The heat exchanger maintains a high temperature at which the fluid vaporizes by flashing. The flashed fluid rapidly expands, which forces the vapor through the nozzle of the machine. If the haze effect must be created at a location distant from the base unit, ductwork can be attached to the base unit 55 to permit the haze to be provided at the distant location.

### SUMMARY

In one general aspect, a hazer system includes a base unit, an air capture unit and an air return line. The base unit is configured to hold a haze fluid and produce a haze, and have one or more outlets from which the haze is emitted. The air capture unit has one or more openings through which a negative pressure exists to capture at least a portion of the haze produced by the base unit. The air return line is configured to return at least a portion of the captured haze to the base unit and/or exhaust at least a portion of the capture haze.

Embodiments of the hazer system may include one or more of the following features. For example, the base unit may include a fan configured to pull air into the air capture unit and through the air return line into the base unit. The air capture unit may include a fan configured to pull air into the air capture unit and exhaust the captured air.

Either or both of the air capture unit and the air return line may include one or more valves to control a proportion of the amount of captured haze that is exhausted and a proportion of the amount of captured haze that is recycled to the base unit. All of the captured haze may be exhausted.

The base unit may include an elongated tube extending from the base unit and the one or more outlets may be positioned on the base unit. The one or more outlets may be openings in the tube.

The air capture unit may include a tube having one or more openings into the tube. The tube may be positioned generally above the base unit.

The hazer system may create a plane of haze primarily positioned between the base unit and the air capture unit.

In another general aspect, there is provided a method of providing a haze in a controlled space while limiting the buildup of haze in the controlled space. The method includes providing a hazer system, operating the hazer system to produce the haze in the controlled space, and operating the hazer system to capture at least a portion of the produced haze in the air capture unit. The hazer system includes a base unit, an air capture unit and an air return unit. The base unit is configured to hold a haze fluid and produce a haze and having one or more outlets from which the haze is emitted. The air capture unit has one or more openings through which a negative pressure exists to capture at least a portion of the haze produced by the base unit. The air return line is configured to return at least a portion of the captured haze to the base unit and/or exhaust at least a portion of the capture haze;

Embodiments of the method may include one or more of the following features. For example, the method may further include providing a fan in the base unit and using the fan to pull air into the air capture unit and through the air return line into the base unit. The method may further include providing a fan in the air capture unit and using the fan to pull air into the air capture unit and exhaust the captured air.

The method may include providing at least one valve in either or both of the air capture unit and the air return line and controlling the positioning of the valve to control a proportion of the amount of captured haze that is exhausted and a proportion of the amount of captured haze that is recycled to the base unit. The method may further include controlling the positioning of the valve so that all of the captured haze is exhausted.

The base unit may include an elongated tube extending from the base unit and the one or more outlets are positioned on the base unit. The one or more outlets may be openings in the tube.

The air capture unit may include a tube having one or more openings into the tube and the tube may be positioned generally above the base unit.

Operating the hazer system may create a plane of haze primarily positioned between the base unit and the air capture unit.

The details of various embodiments of the invention are set forth in the accompanying drawings and the description below. Other features and advantages of the invention will be apparent from the description, the drawings, and the claims.

### DESCRIPTION OF THE DRAWINGS

FIG. 1 is an elevation view of a prior art hazer system.

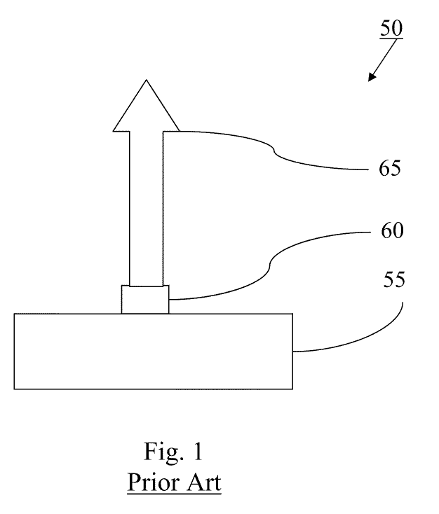

FIG. 2 is an elevation view of a hazer system having an air capture system.

FIG. 3 is an elevation view of a second implementation of the hazer system having an air capture system.

FIG. 4 is an elevation view of a hazer system with a haze fluid capture and recycling system.

### DETAILED DESCRIPTION

The inventor has developed systems and methods for using hazer systems in enclosed environments without creating the undesirable effect of saturating the entire room with the haze. To accomplish this, the hazer system includes an air capture unit that pulls in the haze created by the hazer system.

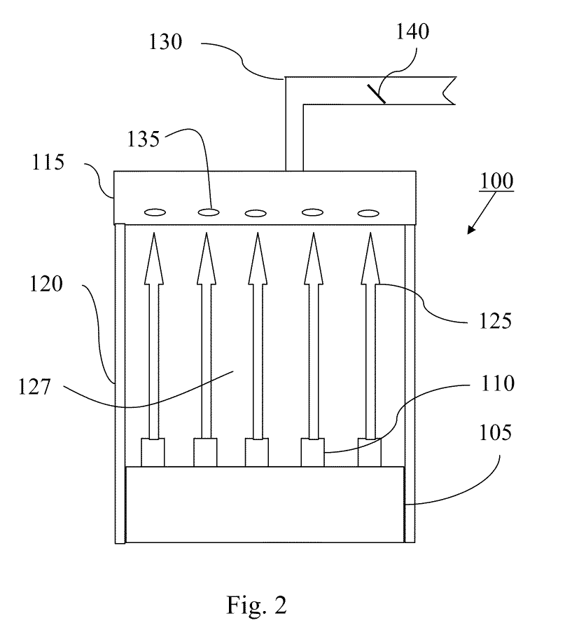

Referring to FIG. 2, a hazer system 100 for providing a lighting effect includes a base unit 105 having one or more outlets 110. The base unit 105 includes a compressor to atomize the fluid or a heat exchanger to vaporize the fluid to create the haze. Depending upon the type of system, i.e., compressor or heat exchanger, the base unit may include a pump that pumps the fluid from a reservoir and a fan to blow the haze from the base unit through the one or more outlets 110. The base unit may be configured such that a tube extends from the base unit and the one or more outlets are positioned on or into the tube.

The hazer system 100 also includes an air capture unit 115 that pulls in the plume of haze 125. The air capture unit 115 can include return lines 120 that feed the captured gas back to the base unit 105 and/or an exhaust line 130 that exhausts the captured gas away from the base unit 105. The net effect of the plumes 125 passing between the one or more outlets 110 and the air capture unit 115 is the creation of a dense plane 127 of haze between the outlets and air capture unit.

The base unit 105 can be configured such that the air capture unit 115 is used to feed the base unit with air or a mixture of air and the haze through the return lines 120. For example, the air capture unit 115 can include one or more openings 135 oriented in the direction of the one or more outlets 110 and the base unit can include a fan (not shown) that pulls the air/haze mixture through the one or more openings 135 into the air capture unit 115, into the return lines 120 and finally back into the base unit 105. The recycled air/haze mixture then can be mixed with the fresh stream of haze gas to form the plume 125. An advantage of this configuration is that the amount of haze fluid used can be reduced because the feed to the system will include a mixture of air and the haze gas. It is expected that some haze fluid will be continually input into the system depending upon the efficiency of the air capture unit, which affects the amount of haze gas that is lost into the room surroundings.

The fan can be controlled such that the operator can decide how much air and haze should be pulled into the air capture unit. For example, the operator may not want the suction noise to be too loud and may reduce the speed of the fan. The operator may want to prevent a noticeable buildup of haze in the room in which the hazer system is placed and thus will increase the speed of the fan to ensure capture of more of the haze produced at the base unit.

The recycling system illustrated by the use of the return lines 120 may be augmented with, or replaced by, the exhaust line 130 to partially or completely exhaust the haze mixture from the room. The ability to exhaust the haze gas may be useful to prevent the room air from becoming too saturated with the haze gas after extended operation. The exhaust line 130 may include a valve 140 that controls the amount of gas that flows through the exhaust line 130.

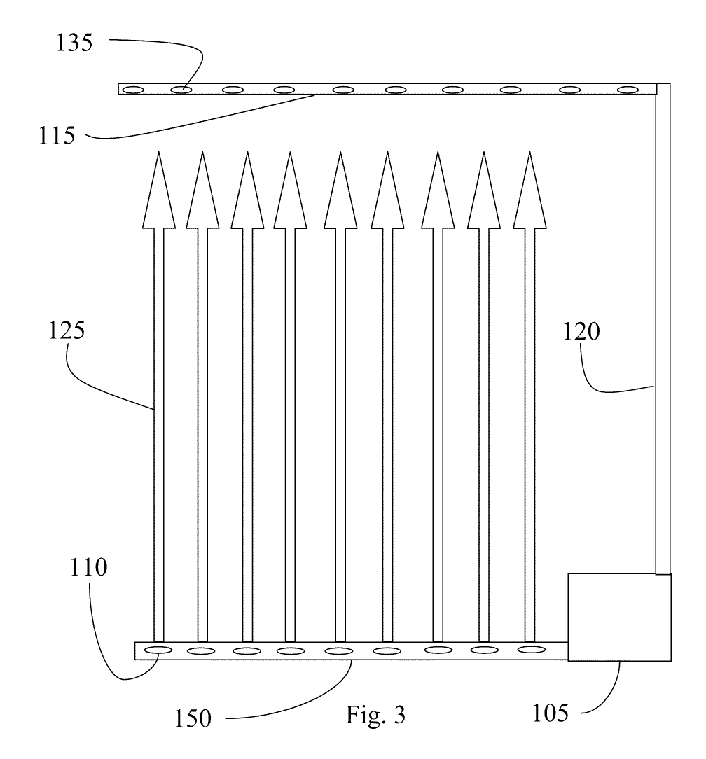

Referring to FIG. 3, in a second implementation of the hazer system with an air capture system, a hazer system 160 includes a tube 150 that extends from the base unit 105. The tube 105 includes the one or more openings 110 from which the haze plumes are emitted. The advantage offered by the haze system 160 is the low profile nature of the tube 150. The hazer system 160 can be arranged to be discretely positioned in a room to be unobtrusive yet create a plane 127 of haze between the tube 150 and the air capture system 115. With the unobtrusive nature of the hazer system 160, the plane of haze can be targeted with lighting effects that rely upon the droplets of fluid that make up the haze. In fact, the hazer system 160 can include components that create the lighting effects in the haze.

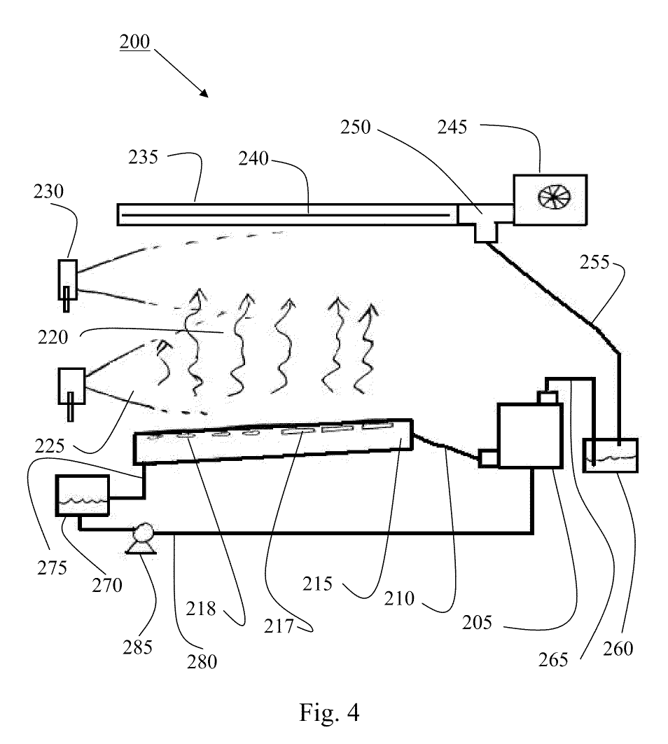

Referring to FIG. 4, a hazer system 200 includes a hazer 205 that supplies a haze fluid through a line 210 that runs from the hazer 205 to a tube 215. The tube 215 includes output slots 217 or output openings 218 through which the haze plumes 220 are emitted. The haze plumes 220 pass through light beams 225 emitted from light fixtures 230. The haze plumes cause the light beams 225 to be a visible light within the haze plume. The haze plumes are pulled in the direction of an exhaust diffuser 235 having openings (not shown) or a slot 240. The haze plumes are pulled into the slot 240 by the negative pressure created by a fan unit 245 coupled to the exhaust diffuser 235. A condensation valve 250 is positioned in line with the exhaust diffuser and the exhaust fan, and serves to provide an outlet to a condensation return line 255 that directs haze fluid condensation to a reservoir tank 260. A feed line 265 runs from the reservoir tank 260 to the hazer 205 to feed haze fluid to the hazer 205. The reservoir tank 260 also receives condensed haze fluid from the tube 215. As might be expected, not all of the haze fluid that is directed into the tube by the hazer 205 diffuses from the tube 215 as a plume. Some of the fluid condenses within the tube 215 and is emptied from the tube to a collection tank 270 through an opening into an input line 275. The collection tank 270 has an output line 280 that includes an inline pump 285 that pumps the condensed fluid to the reservoir tank 260. It should be understood that the reservoir tank also will have an opening or line to feed fresh haze fluid to the system 200.

As noted above, the haze fluid condenses and collected within the tube 215 and the exhaust diffuser 235. To improve the flow of the condensed haze fluid back to the reservoir, the tube 215 and the exhaust diffuser 235 may be tilted at an angle to the horizontal of approximately 2% such that the input line 275 and condensation valve 250 are positioned at the low end of the tube and diffuser, respectively.

In use, the hazer system 200 functions by receiving the haze fluid from the reservoir tank 260 and then heats or atomizes the fluid in the hazer 205. The haze fluid then is pumped or exhausted from the hazer into the tube 215 and diffuses out of the slots 217 or openings 218. The haze fluid that condenses in the tube 215 flows under the force of gravity along the length of the tube to the opening into the input line 275 and into the collection tank 270 where it is then pumped 285 back to the reservoir tank 260.

The haze that diffuses from the tube 215 passes through one or more lighting fixtures configured to direct light through the haze plume. As the light passes through the haze plume, the light will be visible and thereby create a visible lighting effect to an observer of the hazer system 200. The haze plume is pulled into the slot 240 of the exhaust diffuser 235 by the negative pressure created by the exhaust fan 245. The exhaust diffuser can be configured to condense the haze fluid using techniques known in the art. The condensed fluid drains from the exhaust diffuser under the force of gravity to the condensation valve 250 where it then flows into the reservoir tank to be reused.

While several particular forms of the invention have been illustrated and described, it will be apparent that various modifications and combinations of the invention detailed in the text and drawings can be made without departing from the spirit and scope of the invention. For example, references to materials of construction, methods of construction, specific dimensions, shapes, utilities or applications are also not intended to be limiting in any manner and other materials and dimensions could be substituted and remain within the spirit and scope of the invention. Accordingly, it is not intended that the invention be limited, except as by the appended claims.

What is claimed is:

1. A hazer system comprising:
a base unit configured to hold a haze fluid and produce a haze, and having one or more outlets from which the haze is emitted;
an air capture unit having one or more openings through which a negative pressure exists to capture at least a portion of the haze produced by the base unit; and
an air return line configured to return at least a portion of the captured haze to the base unit and/or exhaust at least a portion of the capture haze.

2. The hazer system of claim 1, wherein the base unit includes a fan configured to pull air into the air capture unit and through the air return line into the base unit.

3. The hazer system of claim 1, wherein the air capture unit includes a fan configured to pull air into the air capture unit and exhaust the captured air.

4. The hazer system of claim 1, wherein either or both of the air capture unit and the air return line include valves to control a proportion of the amount of captured haze that is exhausted and a proportion of the amount of captured haze that is recycled to the base unit.

5. The hazer system of claim 4, wherein all of the captured haze is exhausted.

6. The hazer system of claim 1, wherein the base unit comprises an elongated tube extending from the base unit and the one or more outlets are positioned on the base unit.

7. The hazer system of claim 6, wherein the one or more outlets comprise openings in the tube.

8. The hazer system of claim 1, wherein the air capture unit comprises a tube having one or more openings into the tube.

9. The hazer system of claim 8, wherein the tube is positioned generally above the base unit.

10. The hazer system of claim 1, wherein the hazer system creates a plane of haze primarily positioned between the base unit and the air capture unit.

11. A method of providing a haze in a controlled space while limiting the buildup of haze in the controlled space, the method comprising:
providing a hazer system comprising a base unit configured to hold a haze fluid and produce a haze and having one or more outlets from which the haze is emitted, an air capture unit having one or more openings through which a negative pressure exists to capture at least a portion of the haze produced by the base unit, and an air return line configured to return at least a portion of the captured haze to the base unit and/or exhaust at least a portion of the capture haze;
operating the hazer system to produce the haze in the controlled space; and
operating the hazer system to capture at least a portion of the produced haze in the air capture unit.

12. The method of claim 11, further comprising providing a fan in the base unit and using the fan to pull air into the air capture unit and through the air return line into the base unit.

13. The method of claim 11, further comprising providing a fan in the air capture unit and using the fan to pull air into the air capture unit and exhaust the captured air.

14. The method of claim 11, further comprising providing at least one valve in either or both of the air capture unit and the air return line and controlling the positioning of the valve to control a proportion of the amount of captured haze that is exhausted and a proportion of the amount of captured haze that is recycled to the base unit.

15. The method of claim 14, further comprising controlling the positioning of the valve so that all of the captured haze is exhausted.

16. The method of claim 11, wherein the base unit comprises an elongated tube extending from the base unit and the one or more outlets are positioned on the base unit.

17. The method of claim 16, wherein the one or more outlets comprise openings in the tube.

18. The method of claim 11, wherein the air capture unit comprises a tube having one or more openings into the tube.

19. The method of claim 8, wherein the tube is positioned generally above the base unit.

20. The method of claim 11, wherein the operating the hazer system creates a plane of haze primarily positioned between the base unit and the air capture unit.
